(19) United States
(12) Patent Application Publication
(10) Pub. No.: US 2024/0242102 A1
(43) Pub. Date: Jul. 18, 2024

(54) QUANTUM-STATE READOUT ARRANGEMENT AND METHOD

(71) Applicant: IQM Finland Oy, Espoo (FI)

(72) Inventors: Juha Hassel, Espoo (FI); Mikko Möttönen, Espoo (FI)

(21) Appl. No.: 18/559,664

(22) PCT Filed: May 28, 2021
(86) PCT No.: PCT/FI2021/050388

§ 371 Date: Nov. 8, 2023

(51) Int. Cl. G06N 10/40

(52) U.S. Cl. CPC G06N 10/40

(57) ABSTRACT

Disclosed is a quantum-state readout arrangement and a method. A first solid-state qubit may be used for providing a first quantum state and a readout element may be used for determining the first quantum state. The readout element comprises a readout actuator and one or more calorimeters, wherein the dissipation of the readout element is arranged to be dominated by the dissipation stemming from the one or more calorimeters.

### FIELD

The present invention relates to quantum-state readout for a qubit.

### BACKGROUND

In qubit applications, such as quantum computing, a necessary step is the measurement of the quantum state. A typical measurement involves probing the quantum state so that, in the detection sequence, the resulting signal is first amplified with a microwave amplifier. In order to achieve a high-fidelity measurement, the amplifier is required to have very low added noise. Furthermore, especially for the multiplexed readout of multiple qubits, the bandwidth of the amplifier is preferably high. The low noise is characteristically achieved with Josephson parametric amplifiers (JPAs), which are parametric amplifiers based on the Josephson effect (B. Yurke, et al., Phys. Rev. A., 39, 2519, 1989.) or in some cases to superconducting kinetic inductance. The wide bandwidth is achieved with a special class of parametric amplifiers, namely travelling wave parametric amplifiers (TWPAs) based on radio frequency pumped nonlinear microwave transmission lines, with the nonlinearity commonly based on the Josephson effect (O. Yaakobi et al., Phys. Rev. B., 87, 144301, 2013) or less commonly on the kinetic inductance (M. R. Vissers, arXiv:1509.09280, 2015). Improved alternatives are in demand.

### SUMMARY

An objective is to provide an improved scheme for qubit readout.

A readout scheme based on calorimetry is pro-posed, where one or more calorimeters is used to detect signals generated in the readout process. In calorimetry, the signal to be detected is converted, partially or fully, into thermal energy, and the calorimeter produces an output signal, such as an electrical signal, which can be proportional to this thermal energy. For qubit readout, the signal to be provided to the calorimeter is a readout signal, which has been correlated with a quantum state of a qubit, here a solid-state qubit. For the purpose of facilitating the readout signal to be provided from a qubit, a readout actuator can be used for readout of the first quantum state. The quantum state can be correlated with the readout signal so that the latter contains information about the quantum state for determination of the quantum state.

According to a first aspect, a quantum-state readout arrangement comprises a first solid-state qubit for providing a first quantum state and a first readout element for determining the first quantum state. The readout element may comprise a readout actuator for facilitating a readout signal to be provided from the first solid-state qubit for readout of the first quantum state. As a readout signal for readout of the first quantum state is provided, the readout element comprises one or more calorimeters (herein also “the calorimeters”) arranged to receive the readout signal and convert at least a part of the readout signal into thermal energy for providing an output signal for determining the first quantum state. The qubit can thereby be coupled to the calorimeters in such a way that thermal energy absorption, in the calorimeters, of a readout signal for the qubit is dependent on the quantum state. This provides an arrangement where the qubit and the calorimeters are integrated together for readout of the quantum state. Importantly, the calorimeters are not separated from the readout element but are arranged as a part of it. Consequently, a separate readout element can be provided for each qubit of the readout arrangement. As the readout arrangement can comprise a plurality of solid-state qubits, each of the qubits may be coupled to its dedicated readout element, or its dedicated set of one or more calorimeters, for determining its quantum state.

Importantly, for the readout of the quantum state, the dissipation of the readout element may be dominated by the dissipation stemming from the calorimeters. The readout element, including the calorimeters, may be configured accordingly, for example by configuring the intrinsic dissipation of the calorimeters and/or the coupling of the calorimeters with respect to the readout actuator. The dissipation of the readout element may be either fixedly or tunably dominated by the dissipation stemming from the one or more calorimeters for the readout of the first quantum state. By dissipation stemming from the calorimeters, it is not only meant here the intrinsic dissipation of the calorimeters but also how it is visible to the readout element for the readout of the quantum state. Correspondingly, the dissipation stemming from any source referred to herein, such as the calorimeters, may be considered as the effective dissipation pertaining to said source for the readout of the quantum state. The dissipation of the readout element, for the readout of the quantum state, is then the total of such effective dissipation from different sources at the readout element, comprising or at least substantially consisting of the calorimeters and the readout actuator. The calorimeters may thus be arranged for providing larger contribution to the dissipation of the readout element than the readout actuator, or the rest of the readout element altogether. The dissipation of the rest of the readout element, i.e. the readout element excluding the calorimeters, may include dissipation stemming from any transmission line(s) for signal transmission at the readout element for facilitating the readout. For the purpose of this disclosure, any such dissipation may be considered to be part of the dissipation stemming from the readout actuator so that the dissipation of the readout element corresponds to the total dissipation stemming from the calorimeters and the readout actuator. The readout element may have an intrinsic level of dissipation, and, furthermore, in many applications there can be an optimal level of dissipation to have desirable properties such as readout speed and readout system stability. As disclosed, the arrangement can be designed so that the dissipation of the readout element can be optimized while maximizing energy absorption to the calorimeter(s) for the readout.

The dissipation of the readout element may be dominated by the dissipation stemming from the calorimeters at least in two ways. First, the readout element may be arranged for the dissipation stemming from the calorimeters to be fixedly larger than the dissipation stemming from the readout actuator. As an alternative the dissipation stemming from the calorimeters may be adjustable with respect to the dissipation stemming from the readout actuator in such a manner that the former can be made larger than the latter upon selection. For these purposes, the intrinsic dissipation of the calorimeters and/or the coupling between the calorimeters and the readout actuator may be fixed or adjustable, respectively.

As the state of art with solid-state, and especially superconducting qubits rely on JPAs or TWPAs, the disclosed thermal detection arrangement may also be compared to these. As detailed below, many of the effects of using the disclosed arrangement with thermal detection relate to the potential of scaling the readout with increasing qubit count, and as an enabler of more integrated solutions.

A general effect of the arrangement is that the calorimeters can be, in a straightforward manner, configurable to adopt to a desired frequency band. In prior art the bandwidth requirements are typically addressed with TWPAs which are characteristically relatively bulky, consisting of thousands of Josephson junctions and physical size in the range from tens of square millimeters to hundreds of square millimeters. In contrast, the active elements of the calorimeters may be smaller than one hundred square micrometers for converting the at least a part of the readout signal into thermal energy for providing the output signal for determining the first quantum state. This may be used to allow scaling up of qubit systems, especially in the context of integrated readout solutions. A further effect of the integrated arrangement as disclosed is that certain it allows the use of calorimeters which are more readily compatible with the fabrication techniques of the qubit circuits, in comparison to the typical amplifier arrangements.

A further point of note is that the power consumption of a typical TWPA is between −70 dBm and −60 dBm provided as RF (radio frequency) or microwave “pump tone”. While this is not necessarily restrictive in the existing qubit systems, it may set limitations through local heating in integrated solutions. In contrast the calorimeters in accordance with the present disclosure, or the pump power thereof, may be arranged for use of a readout power less than −70 dBM, for example −90 dBm or less. In an embodiment, the readout power for the calorimeters may be −126 dBm or less, for example −132 −126 dBm, i.e. about six orders of magnitude less than that of a typical TWPA.

Considering the sensitivity needed in the readout, TWPAs are typically operated in a phase-insensitive mode where the standard quantum limit setting a minimum achievable resolution as defined by noise temperature Tₑ=hf/(2k_{b}) corresponding to the added noise of the amplifier. In principle the parametric amplifiers can be operated in the so called squeezed (phase-sensitive) mode where the restriction does not apply.

However, in a wide-band operation with TWPA the conditions for squeezing are in practice hard to obtain. For calorimeters, due to their nature as pure amplitude detectors, such fundamental restrictions do not apply.

In an embodiment, the readout actuator comprises or consists of a resonator, such as a linear resonator. This can be coupled to the one or more calorimeters and the first solid-state qubit for forming a resonance circuit for the readout of the first quantum state. The resonance circuit may have a first quality factor indicating the intrinsic dissipation of the resonator. Typically, this intrinsic dissipation can stem from nonidealities such as dielectric losses at the resonator, which may result for example from native surface oxides on the resonator and/or on a substrate supporting the resonator. The first quality factor can be characteristic to the geometric and/or fabrication details of the resonator. The resonance circuit may also have a second quality factor indicating the dissipation stemming from the one or more calorimeters. The second quality factor can depend on the impedance of the calorimeters and on the coupling of the calorimeters to the resonator, either or both of which may be tunable. It may be configured by choosing the parameters of the calorimeters and the coupling element(s) for coupling the calorimeters to the resonator. In an embodiment the second quality factor is smaller than the first, and the readout element may be configured accordingly. This allows the dissipation of the readout element to be dominated by the dissipation stemming from the calorimeters when a resonator is used as the readout actuator.

The quality factors referred herein may be understood as the quality factors for the resonance circuit for readout of the first quantum state. While they are represented as the quality factors of the resonance circuit, they may also be considered as the quality factors of the readout element and/or the resonator. Quality factors for a resonance circuit can also be known in the art as Q factors.

In general, for the present disclosure, the quantum-state readout arrangement may comprise an input line (which may also be provided and referred to as a readout line but for clarity is here mostly referred to here as the “input line”) to which one or more readout elements may be coupled with their respective qubits for readout of the quantum states of the qubits. Correspondingly, the readout element, or the resonance circuit, may also have a third quality factor stemming from the coupling of the readout element (or the readout actuator thereof) to the input line. The third quality factor may thereby be considered as an external quality factor for describing the coupling of the readout element, with its corresponding qubit, to the input line. Nevertheless, the third quality factor can be independent or substantially independent of the number of readout elements and/or qubits coupled to the input line. This is possible as a readout element/qubit effectively interacts only with the input line and not with other readout elements/qubits coupled to the input line. For this purpose, the resonators of different readout elements may be tuned at different frequencies. The impedance of the input line may be substantially independent of the number of readout elements and/or qubits coupled to it. In an embodiment, the second quality factor may be arranged to be at least substantially the same as the third quality factor, which may be used to optimize the dissipation of the arrangement for the readout of the quantum state. For example, the higher of the two quality factors may be at most 50 percent larger than the smaller. In an embodiment, the number is only 10 percent.

In general, the dissipation stemming from the input line may be considered separate from the dissipation of the readout element, e.g. as an external dissipation.

In an embodiment, the arrangement comprises one or more second solid-state qubits for providing one or more second quantum states and, correspondingly, one or more second readout elements for determining the (corresponding) second quantum state. The second readout element may comprise a resonator, such as a linear resonator, for readout of the second quantum state. The resonator of the first readout element may have a first resonance frequency and the second readout resonator may have a second resonance frequency different from the first resonance frequency. This allows several qubits to be addressed through a single input line. Several qubits may be addressed at the same time by providing an input signal (also referred to herein as probe signal), for providing the readout signal, as a frequency comb having frequency components corresponding to different resonance frequencies. Alternatively, the input signal may can comprise or consist of single frequency tones switched in time domain. The first and second resonance frequencies referred herein may be understood as the resonance frequencies for the resonance circuit for readout of the first and second quantum state, respectively. Any or all of the resonators of the different second readout elements may have a different resonance frequency with respect to each other and to the first resonance frequency.

In an embodiment, the readout actuator comprises or consists of a Josephson transmission line (JTL). The JTL may be configured for having a Stewart-McCumber parameter β_{c}<100 for readout of the first quantum state. This allows the dissipation of the readout element to be dominated by the dissipation stemming from the calorimeters, when a JTL is used as the readout actuator.

In an embodiment, the output signal for determining the first quantum state is provided from the one or more calorimeters based on the magnitude of the thermal energy. Correspondingly, the readout can be arranged so that energy absorbed in the calorimeter is a fraction of the readout signal proportional to the quantum state.

In an embodiment, the output signal for determining the first quantum state is provided from the one or more calorimeters based on the timing of the conversion of the readout signal into thermal energy. Correspondingly, the readout can be arranged so that the timing of the energy absorption is dependent on the quantum state, which can be utilized for determining what the state of the qubit is.

In an embodiment, the one or more calorimeters comprise or consist of one or more electron temperature calorimeters. This allows the calorimeters to be provided with low heat capacity, which may in turn allow improving their response for determining the quantum state.

In an embodiment, the arrangement, or the readout element, comprises an input line for providing an input signal for providing the readout signal and one or more Purcell-filters coupled between the input line and the one or more calorimeters for suppressing the decay of the first quantum state due to the one or more calorimeters. This may be used to allow increasing the decoherence time for the qubit.

In an embodiment, dissipation stemming from the one or more calorimeters is tunable. This may be used to allow the dissipation to be turned on and off where needed. For example, the readout arrangement may be configured for decreasing, e.g. minimizing, the dissipation stemming from the calorimeters during quantum evolution of the solid-state qubit. Alternatively or additionally, the readout arrangement may be configured for increasing, e.g. maximizing, the dissipation stemming from the calorimeters for readout of the quantum state.

In an embodiment, the arrangement, or the readout element, comprises a tunable reactance coupled to the one or more calorimeters for tuning the dissipation stemming from the one or more calorimeters. This is seen to provide an effective way of tuning the dissipation of the readout element as it allows altering how dissipation due to the calorimeters couples to the readout actuator.

In an embodiment, the arrangement comprises a first chip and one or more second chips. The first solid-state qubit may be integrated on the first chip and the one or more calorimeters may be integrated on the one or more second chips. This allows separating the layer stacks of the qubit circuit and the readout circuit, thereby providing flexibility in manufacturing and de-signing the readout arrangement. For example, the qubit and the readout element can be obtained from dedicated manufacturing stages that can be separately optimized. It also enables decreasing qubit decoherence by necessitating fewer fabrication steps on the qubit chip, thereby avoiding contamination.

In an embodiment, one of the first chip and the second chip is flipped on top of the other and an electrical connection between the first chip and the second chip for readout of the quantum state is arranged by reactive coupling between the first chip and the second chip. This enables an effective way of coupling the two separate chips for readout utilizing the calorimeters.

In an embodiment, the one or more calorimeters comprises or consist of two or more calorimeters in cascade for providing the output signal for determining the first quantum state. This allows relaxing the requirements of any post-amplification stages.

As discussed herein, the readout signal can be correlated with the quantum state so that the readout signal contains information about the quantum state for determination of the quantum state. The readout signal may be provided by correlating an input signal with the quantum state. Such an input signal (also “probe signal”) can thus be used to probe the quantum state for providing the readout signal. Correspondingly, the disclosed arrangement may be a cQED (circuit quantum electrodynamics) readout arrangement. For providing the input signal for the readout signal, the arrangement may comprise a signal source, such as a microwave source.

However, there are also other alternatives, for example generating a fluxon correlated with the quantum state for providing the readout signal. Correspondingly, the disclosed arrangement may be an SFQ (single flux quantum) readout arrangement. For utilizing fluxons, the arrangement may comprise fluxon source as a signal source. The readout arrangement may thereby be arranged for fluxon propagation within the readout arrangement to be affected by the first quantum state. As an example, a fluxon may propagate or not within the readout element dependent on the quantum state and/or the timing of the fluxon propagation may be dependent on the quantum state. Fluxons may be utilized for providing the readout signal, for example, when the JTL is used as the readout actuator or as a part thereof, as described above. The single flux quantum techniques can be used in different ways to read out quantum states. The readout may be based on detecting the magnetic flux related directly or indirectly to the quantum state. The readout signal may be a fluxon propagating in the Josephson transmission line. The quantum state may also be determined based on a fluxon being emitted or not emitted depending on the quantum state. Alternatively or additionally, the quantum state may be determined based on the timing information of an emitted fluxon.

While the disclosure is here presented in terms of an arrangement, it can alternatively be provided as a device or an apparatus.

Any area sizes indicated in this disclosure for components may refer to the area the component in question occupies when integrated on a chip.

According to a second aspect, a method for quantum-state readout is provided. The method may comprise providing a readout signal correlated with a quantum state of a solid-state qubit for readout of the quantum state. It may comprise receiving in one or more calorimeters the readout signal for readout of the quantum state. It may comprise converting at least a part of the readout signal in the one or more calorimeters into thermal energy for providing an output signal for determining the quantum state. The dissipation for the quantum-state readout may be fixedly or tunably dominated by the dissipation stemming from the one or more calorimeters for the readout of the quantum state. A readout element comprising a readout actuator, such as a resonator or a JTL, and the one or more calorimeters may be configured for this purpose. Any effects, procedures and structures described in the context of the first aspect and its embodiments are readily applicable also in the context of the second aspect.

It is to be understood that the aspects and embodiments described above may be used in any combination with each other. Several of the aspects and embodiments may be combined together to form a further embodiment of the invention.

### BRIEF DESCRIPTION OF THE DRAWINGS

The accompanying drawings, which are included to provide a further understanding and constitute a part of this specification, illustrate examples and together with the description help to explain the principles of the disclosure. In the drawings:

FIGS. 1a-d illustrate readout elements or parts thereof according to various examples,

FIG. 2 illustrates an arrangement according to an example in a side view, which may also be a cross-sectional view,

FIG. 3a illustrates an arrangement according to an example,

FIG. 3b illustrates an example of power absorption for an arrangement,

FIGS. 4-8 illustrate arrangements according various examples, and

FIG. 9 illustrates a method according to an example.

Like references are used to designate equivalent or at least functionally equivalent parts in the accompanying drawings.

### DETAILED DESCRIPTION

The detailed description provided below in connection with the appended drawings is intended as a description of examples and is not intended to represent the only forms in which the example may be constructed or utilized. However, the same or equivalent functions and structures may be accomplished by different examples.

Disclosed is a readout element and a quantum-state readout arrangement (or a quantum-state readout apparatus/device, also referred to herein simply as “the readout arrangement”).

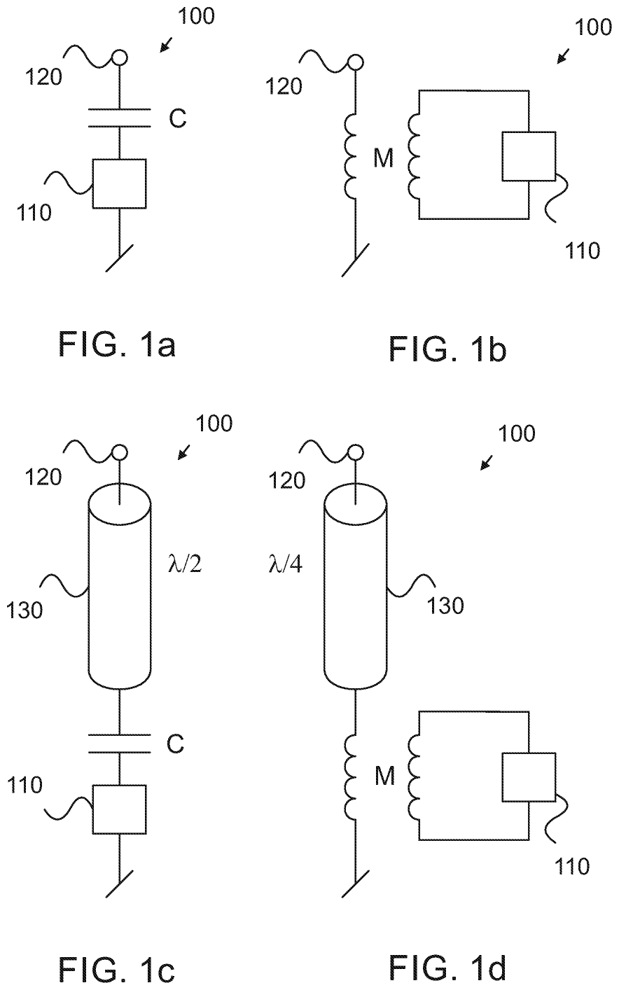

FIGS. 1a-d show examples of readout elements 100, or parts thereof, for determining a quantum state, when coupled to a solid-state qubit (also herein simply “the qubit”) for providing the quantum state. The readout element may be coupled to the quantum state directly or indirectly through a coupling point 120 as illustrated in the figures. In general, in accordance with the present disclosure, such a readout element comprises one or more calorimeters 110 (also referred to herein as “the calorimeters”). The calorimeters are dissipative elements and their intrinsic dissipation may be fixed or tunable. For example, they may be illustrated as resistors having a fixed or tunable resistance, or impedance elements having a fixed or tunable impedance. Correspondingly, the calorimeters may have a tunable resistance and/or impedance. The readout element may also have one or more fixed and/or tunable reactances coupled to the calorimeters for tuning the dissipation stemming from the calorimeters. This allows the dissipation of the calorimeters observable at a different part of the circuit to be altered. The readout arrangement may be formed as a radio frequency (RF) circuit, so that the calorimeters may be represented as dissipative loads in the RF circuit. The calorimeters may comprise or consist of phonon-temperature calorimeters. However, in an embodiment, the calorimeters may also comprise or consist of electron temperature calorimeters. In general, the calorimeters may be configured to act as thermal detectors for determining the quantum state.

A basic scheme is to organize the readout in such manner, that energy absorbed in the calorimeter is a fraction of the readout signal proportional to the state of the qubit. This way, the readout element can be configured for determining the quantum state based on an amount of energy absorbed, i.e. based on the magnitude of the thermal energy. In another embodiment, the timing of the energy absorption can be made dependent on the quantum state, so that the readout element can be configured for determining the quantum state based on this timing.

The readout element is configured for a readout signal to be provided to the calorimeters. The readout signal may be provided from the qubit so that it is correlated with the quantum state of the qubit in a manner that the quantum state can be determined from the readout signal. The readout element may comprise a readout actuator, which may facilitate providing the readout signal from the qubit to the calorimeters in a correlated manner for determining the quantum state. As is known to a person skilled in the art of quantum readout, or as is shown below, such a readout actuator need not be a complicated contraption, although different effects can be provided by different solutions. The readout signal may be an electric and/or magnetic signal, such as an electric current signal or an electromagnetic wave signal. The readout signal may be a pulse signal.

For readout of quantum state, both the speed and/or the energy resolution of the calorimeters may be optimized to facilitate detection of small-energy readout signals with sufficient rate as needed for the readout. The thermodynamic limit of the energy resolution of an ideal calorimeter e may be written as square root of 2πk_{b}*T²*C where C is the heat capacity of the calorimeter, k_{b} is the Boltzmann constant and T is the temperature of the calorimeter (for an electron temperature calorimeter, this may be the electron temperature, instead of the typical lattice temperature of phonons). The thermal time constant can be written as τ=C/G, where G is the thermal conductance, and this may set the scale for the detection speed, if limited by thermal effects. Thus, minimizing both ε and τ may involve minimizing the heat capacity C. Correspondingly, for the present disclosure the calorimeters may comprise or consist of nanocalorimeters, which may have an ultra-low heat capacity C. In typical embodiments, ε/hf may be in the order of unity (e.g. 1-10) or below (with h the Planck constant and f the frequency of the qubit readout). The calorimeters may be configured for providing thermal speed may obey 1/(2πτ)>10 kHz allowing an improved detection rate. The calorimeters may comprise or consist of nanocalorimeters relying on proximity-induced temperature-dependent inductance and/or nanocalorimeters based on superconductor-insulator-normal or superconductor-insulator-normal-insulator-superconductor (SINIS) tunnel junction(s). In particular, any of these examples may be used as electron-temperature calorimeters. In general, the calorimeters may have a low heat capacity for determining the quantum state. This may be achieved in a calorimeter based on detecting electron temperature in a nanoscopic and/or a mesoscopic structure, in which electrons are decoupled from phonons. Calorimeters based on proximity-based superconducting-normal metal junctions and superconductor-insulator-normal-superconductor junctions may be used as thermal detectors. In some embodiments, electron-temperature dependent impedance changes can be recorded with RF techniques.

The coupling of readout element, and thereby also the calorimeters, to the qubit may be performed reactively, including capacitively and/or inductively. This may involve using a reactive element such as a capacitive element, e.g. a capacitor, and/or a mutual inductance. The illustrations in FIG. 1a-d may be interpreted as indicating ways to couple the calorimeters to the any components of the readout element, qubit, and/or to a circuitry comprising the qubit. In addition to the qubit itself, the circuitry can comprise one or more further coupling elements such as capacitors further defining the coupling of the qubit to the readout element. Below, “the qubit circuitry” may therefore also simply refer to the qubit. In an example, as illustrated in FIG. 1a, the coupling of the calorimeters to the qubit circuitry can be performed capacitively. For this purpose, a capacitive element C, such as a capacitor, may be arranged between the qubit circuitry, or its coupling point 120, and the calorimeters 110, for example in a series connection. In another example, as illustrated in FIG. 1b, the coupling can be performed inductively, for example through a mutual inductance M of two inductive elements. The calorimeters 110 can be located at a first circuit, which has a first inductive element that is coupled to a separate second circuit having the qubit, or its coupling point 120, and a second inductive element, through the mutual inductance between the first and the second inductive element.

The calorimeters, in accordance of the present disclosure, can be arranged as a part of the readout element itself, where the readout element may be dedicated to a single qubit. Correspondingly, the calorimeters may be arranged to be coupled to one and only one qubit for determining its quantum state. The calorimeters are arranged to receive the readout signal and convert at least a part of the readout signal into thermal energy for providing an output signal for determining the quantum state. The output signal may be an electric and/or magnetic signal, such as an electric current and/or voltage signal and/or an electromagnetic wave signal. For example, it may be an electrical signal directly indicative of the quantum state. Importantly, the dissipation of the readout element can be arranged to be dominated by the dissipation stemming from the calorimeters. The readout element may comprise one or more transmission lines for coupling together the qubit, the readout actuator and the calorimeters for providing the output signal. However, the calorimeters may be arranged for providing dissipation (visible to the readout element for the readout) that is larger than any dissipation stemming from the readout actuator and these transmission lines, or from the rest of the readout element altogether. The transmission line(s) of the readout element may be considered as part of the readout actuator. The dissipation stemming from the transmission line(s) may be considered as part of the dissipation stemming from the readout actuator. Correspondingly, the dissipation of the readout element may consist or at least substantially consist of the dissipation stemming from the calorimeters and the readout actuator.

The readout element may comprise a feeder line to which an input line of the readout arrangement may be coupled for providing the input signal for providing the readout signal for readout of the first quantum state to the calorimeters. The input line may be arranged as a transmission line through which an input signal can be provided to one or more readout elements each coupled to their own dedicated qubit. A signal source may be coupled to the input line for providing the input signal through the input line to the one or more readout elements. The input line can thereby be considered as a common bus serving multiple qubits, each of which may be coupled to the input line together with their own readout element performing the actual readout. On the other hand, the readout element may be provided as a dedicated element for performing readout of a single qubit upon receipt of an input signal, which may be obtained from the input line.

In an embodiment, the readout actuator comprises or consists of one or more resonators (possibly including the transmission lines as discussed above), such as linear resonators (here also “the resonators” and the resonators may also be referred to as readout resonators). The resonators can be coupled to the feeder line, where the one or more transmission lines mentioned above may comprise or consist of the feeder line, for providing the readout signal for readout of the first quantum state. The resonators may be coupled to the one or more calorimeters and to the first solid-state qubit for forming a resonance circuit for the readout of the first quantum state. The resonance circuit has a first quality factor indicating the intrinsic dissipation of the resonators and this may correspond to the intrinsic quality factor of the resonators. The resonance circuit also has a second quality factor, smaller than the first quality factor, indicating the dissipation stemming from the one or more calorimeters for the readout of the quantum state. This dissipation may be smaller than the intrinsic dissipation of the calorimeters as it may depend also on the coupling of the calorimeters to the readout actuator. The important dissipations here are the dissipations visible to the resonance circuit for the readout of the quantum state. The resonators may be RF resonators, such as linear RF resonators. Importantly, in accordance with the present disclosure, the calorimeters, and correspondingly the dissipation of the readout element stemming from them, can be arranged as part of a resonance circuit corresponding to a resonator of the resonators coupled to its corresponding qubit.

FIGS. 1c and 1d illustrate examples, where the readout actuator comprises one or more resonators 130, such as linear (RF) resonators. The resonators may each have a resonance frequency, which may be fixed or tunable. The dissipation of the readout element for the readout may depend both on the resistance of the calorimeters and the parameters of coupling the calorimeters to the qubit. The calorimeters 110 may be coupled to the resonators 130 reactively, including capacitively and/or inductively. This may involve using a reactive element such as a capacitive element, e.g. capacitor, and/or a mutual inductance. As in FIG. 1c, the calorimeters 110 may be coupled to the resonators 130 capacitively. For this purpose, a capacitive element C, such as a capacitor, may be arranged between the calorimeter 110 and the resonator 130. Similarly, the calorimeters 110 may be coupled to the qubit through the resonators 130 capacitively. For this purpose, a capacitive element C, such as a capacitor, may be arranged between the qubit, or its coupling point 120, and the calorimeters 110, for example in a series connection. In both cases, the capacitive element C may be situated, for example as illustrated, between the calorimeters 110 and the resonators 130, for example in a series connection. In another example, as illustrated in FIG. 1d, the coupling between the resonator and the calorimeters can be performed inductively, for example through a mutual inductance M of two inductive elements. Similarly, the coupling between the qubit and the calorimeters can be performed through the resonators inductively, for example through a mutual inductance M of two inductive elements. In both cases, the calorimeters 110 can be located at a first circuit, which has a first inductive element that is coupled to a separate second circuit (which may have the qubit, or its coupling point 120,) and a second inductive element, through the mutual inductance between the first and the second inductive element. As illustrated, the resonators 130 may be situated at the second circuit, for example between the qubit, or its coupling point 120, and the second inductive element, for example in a series connection.

The readout element, or the readout actuator, may comprise a single dedicated resonator for each qubit.

The readout arrangement may comprise a (first) solid-state qubit for providing a (first) quantum state and a readout element for determining the quantum state. The readout element may be any readout element described herein, or a combination thereof. The arrangement may also comprise an additional reactive coupling between the readout element and the qubit. The arrangement may also comprise a signal source for providing the readout signal. The signal source may be, for example, a microwave source or a fluxon source. The signal source may be a continuous source and/or a pulse source, for example a continuous microwave source and/or a pulsed microwave source. The signal source may provide an input signal for providing the readout signal. The signal source may be arranged to provide the input signal to the input line. The input line may be arranged to direct the input signal to one or more readout elements for providing the readout signal. The readout signal may be provided by correlating an input signal with the quantum state of the qubit. For this purpose, the readout element, or the readout actuator, may be utilized.

Naturally, the quantum-state readout arrangement may comprise one or more additional solid-state qubits for providing one or more additional quantum states. The readout arrangement may comprise a corresponding number of readout elements so that the first solid-state qubit and the one or more additional solid-state qubits each are coupled to their own separate readout element. As the calorimeters are part of the readout element, each qubit may thus be associated with its own dedicated set of one or more calorimeters for determining its quantum state. One or more signal sources may be arranged to serve the whole readout arrangement.

The qubit(s) may comprise or consist of any type of solid-state qubits, for example superconducting qubits. These may include, for example, charge qubits, flux cubits or phase qubits. In view of the present disclosure, their total number may be anything without an upper limit. Even for a simple readout arrangement, the number of qubits may be 10 or more and for a concrete application the number may, for example, be 100 or more.

The readout arrangement may comprise one or more input lines, which may be coupled to the feeder line of one or more readout elements for providing the input signal for providing the readout signal. In some embodiments, a single input line may be used for all the readout elements of the readout arrangement. The input line may be coupled to the one or more signal sources for providing the input signal for providing the readout signal.

The readout arrangement may comprise one or more chips on which the readout element(s) and the qubit(s) are provided, for example by integration thereon. A (first) readout element 100 may be completely or partially contained on the same physical chip as a (first) solid-state qubit. The readout element 100 may also be contained on one or more separate chips with respect to its corresponding qubit. Correspondingly, the readout element(s) may be partially or fully arranged on one or more readout chips, which can be different from one or more qubit chips, on which the qubit(s) corresponding to the readout element(s) are arranged. In particular, the calorimeters may be integrated on the one or more readout chips but, alternatively or additionally, the readout actuator(s), such as the resonator(s), may be integrated thereon as well. The readout chip(s) and the qubit chip(s) may be coupled together for forming an electric connection for readout of the quantum state by one or more galvanic electric connections, for example by wire bonding or flip-chip bonding. The galvanic electric connection(s) may be formed, for example, by bump bonds. These may be superconducting, which has been found to provide additional efficiency. The readout chip(s) and the qubit chip(s) may also be coupled together for forming an electric connection for readout of the quantum state by reactive coupling, or inter-chip reactive coupling. This may be arranged through RF electric and/or magnetic fields with reactance arranged between the two chips. The reactance may be provided by inductance and/or capacitance, for example by one or more reactive elements such as capacitive elements, e.g. capacitors, and/or inductive elements, e.g. by mutual inductance.

FIG. 2 illustrates an example of a readout arrangement 200 comprising a first chip 210 and a second chip 220. The first chip 210 may be a readout chip and the second chip 220 a qubit chip, or vice versa. The first chip may be positioned partially or fully on top of the second chip. The first chip may be flipped so that it is facing the second chip for forming an electric connection for readout of the quantum state, for example by a galvanic electric connection and/or by reactive coupling. The readout arrangement may comprise one or more elements 230 between the two chips 210, 220, which may be arranged for providing support and/or forming the electric connection, such as a galvanic electric connection, for readout of the quantum state. Depending on their application, the one or more elements may be electrically conductive, such as bump bonds, or non-conductive. Alternatively or additionally to the galvanic electric connection, the readout arrangement may also comprise one or more reactive elements C, M, as de-scribed above, for forming the electric connection for readout of the quantum state.

The readout arrangement may be an arrangement, such as a cQED readout arrangement, where the calorimeters are coupled as dissipative elements to the resonators for readout of the quantum state. A loss level corresponding to the dissipation stemming from the calorimeters may be quantified by a quality factor Q_{c}, which may be arranged dominate over the intrinsic losses of the readout element, such as intrinsic, e.g. dielectric, losses of the resonator. This intrinsic loss level may be quantified by a quality factor Qᵢ, so that Q_{c}<Qᵢ or Q_{c}<<Qᵢ). This may be considered as the quality factor for the readout actuator, which may also include any losses pertaining to any transmission line(s) of the readout element. According to the principles of cQED, the resonance frequency of the resonator f₁ may depend on the qubit state. The state-dependent resonance frequencies may be denoted as f_{i,|0>} or f_{i,|1>}, for quantum states |0> or |1>, respectively, where i indicates an index to the qubit in question. The readout may be performed by feeding RF signals, such as RF pulses, of frequency f_{g} corresponding to either of the frequencies f_{i,|0>} or f_{i,|1>}. Here, “corresponding” may be understood as the frequency of the RF pulse being sufficiently close to the frequency f_{i,|0>} or f_{i,|1>} to be able to probe the qubit-state dependent resonator frequency. The readout actuator may be arranged to comprise or consist of one or more resonators such that the readout signal can be absorbed by the calorimeters for determining the quantum state if the probe frequency f_{g} corresponds to the resonance frequency. This may involve substantially complete absorption of the readout signal by the calorimeters, or an absorption above a threshold level. For optimizing the absorption, the readout arrangement may have an input line for which the loss level can be quantified by an external quality factor Qₑ. In an embodiment, Qₑ≈Q_{c}. The absorption can thus be selective to the quantum state |0> or |1>. Different qubits may have a different resonance frequency, which allows to address several qubits through a single input line. Several qubits can be addressed at the same time by com-posing the probe signal as a frequency comb having frequency components corresponding to different resonance frequencies. Alternatively, the readout signal may consist of single frequency tones f₁ switched in time domain. In general, the readout arrangement may thus be a multiplexed readout arrangement with different resonance frequencies for different qubits.

The fidelity of the readout may be dependent on the energy of the readout signal, which may be ex-pressed as a photon number in the resonators. With and increasing photon number, an upper limit (breaking the validity of the dispersive limit) may be set as the signal level starting to excite unwanted qubit transitions. Under proper conditions, with a thermal detector, as disclosed herein, it may be possible to store the photons thermally instead of storing them in the resonators which may allow for larger readout amplitudes.

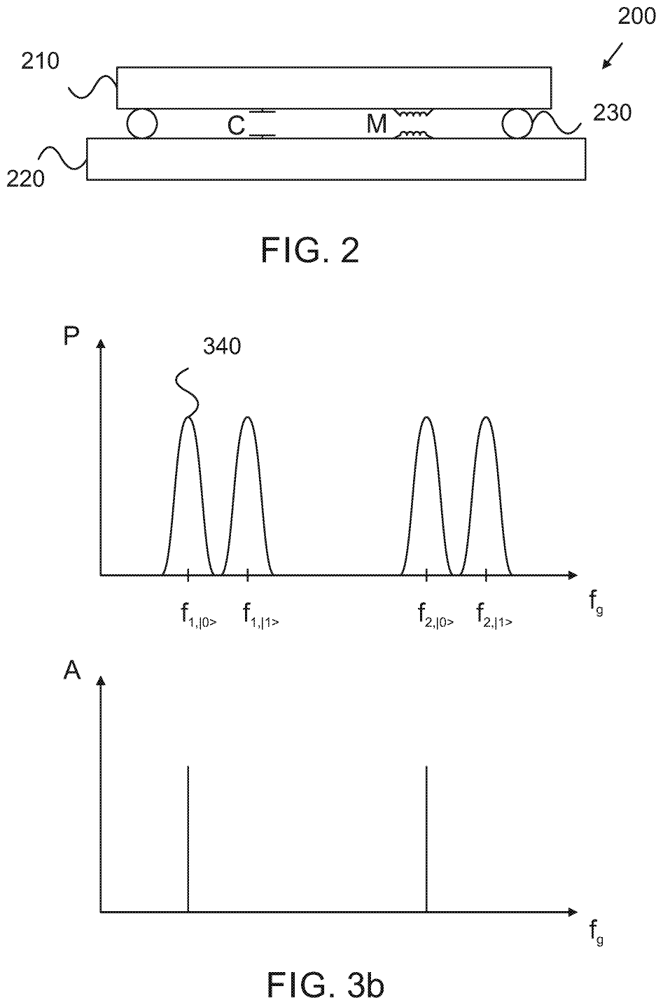

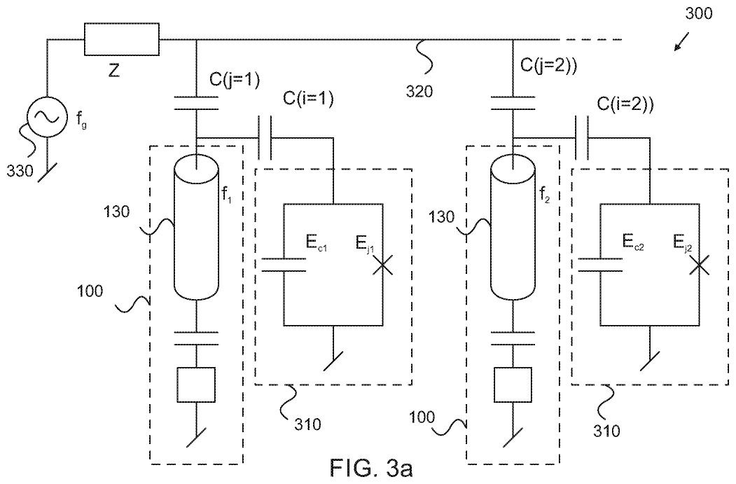

FIG. 3a illustrates an arrangement 300, such as a cQED readout arrangement, according to an example. The arrangement may be considered to illustrate any of the readout arrangements disclosed herein, wherein the readout elements comprises the resonators.

The arrangement 300 comprises one or more readout elements 100 and solid-state qubits 310, where each qubit may have its own designated readout element. The readout element(s) may be in accordance with any of the readout element(s) described herein, for example those illustrated in FIGS. 1a-d. The qubit(s) may be coupled to the readout element reactively, for example by an indicative connection and/or a capacitive connection C(i), where i may indicate the index of a qubit, as the strength of the connection may be the same or different for different qubits.

The arrangement 300 may comprise one or more input lines 320 for providing the input signal for providing the readout signal. The readout element(s) may be coupled to the input line(s), for example reactively. This may be done through by an inductive connection and/or a capacitive connection C(j), where j may indicate the index of a readout element qubit, as the strength of the connection may be the same or different for different readout elements. Each qubit having their own dedicated readout element, the index of the readout element j may naturally correspond the index of the qubit i. The arrangement may comprise one or more signal sources 330 for providing the input signal. The input signal may have frequency f_{g}. The input line, together with the signal source(s), may exert an input impedance Z for the input signal.

As illustrated, the resonators of different readout elements 130 have resonance frequencies f₁, f₂, which may be different from each other. As indicated above, this may have various effects, for example when a single input line 320 is used for multiple qubits 310, as illustrated. In particular, it is noted that using a single input line for multiple qubits allows simultaneous readout for the multiple qubits.

FIG. 3b illustrates an example of power absorption for a readout arrangement, for example in accordance with FIG. 3a. In the upper graph, an example of power absorption dependent on the quantum state is illustrated. The power absorption spectrum has peaks 340 at resonance frequencies, which are different for different quantum states of a qubit (|0> or |1>). However, when the readout elements for different qubits each have a resonator with different resonance frequency (f₁ and f₂), the peaks are also shifted in accordance with this resonance frequency, allowing the quantum state of a specific qubit to be determined from the power absorption spectrum based on, for example, the presence or absence of a peak for a resonance frequency. For maximal fidelity a readout signal may be used having a frequency corresponding to f_{1,|0>}, f_{1,|1>}, f_{2,|0>} and/or f_{2,|1}>.

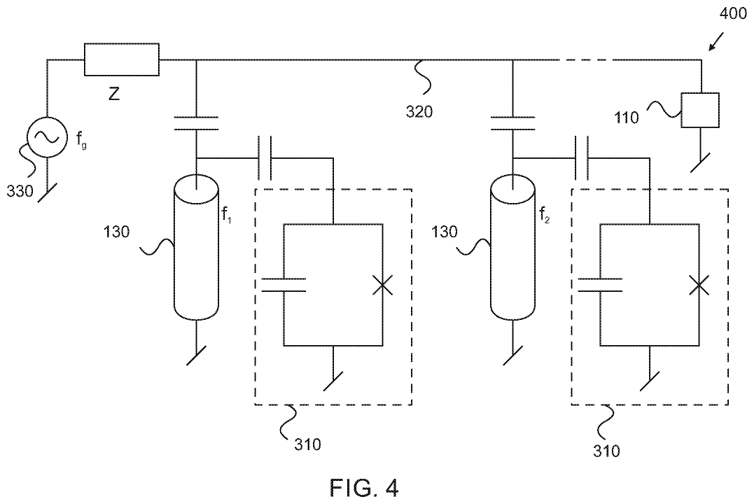

In contrast to the previous example, FIG. 4 illustrates an arrangement 400 where a single calorimeter is utilized for readout of multiple qubits. In this case, the calorimeter acts as a detector for the whole readout system.

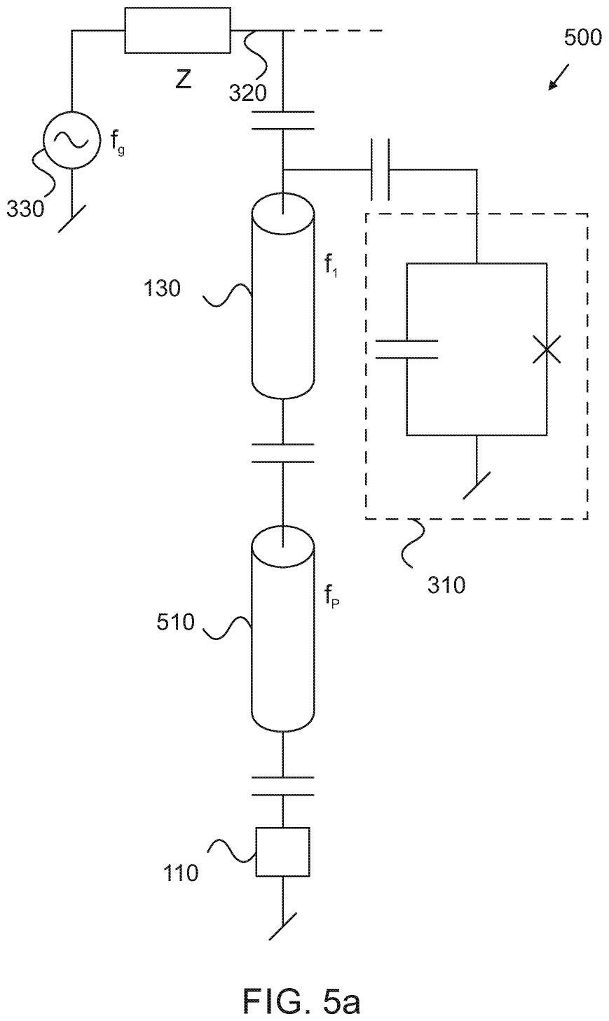

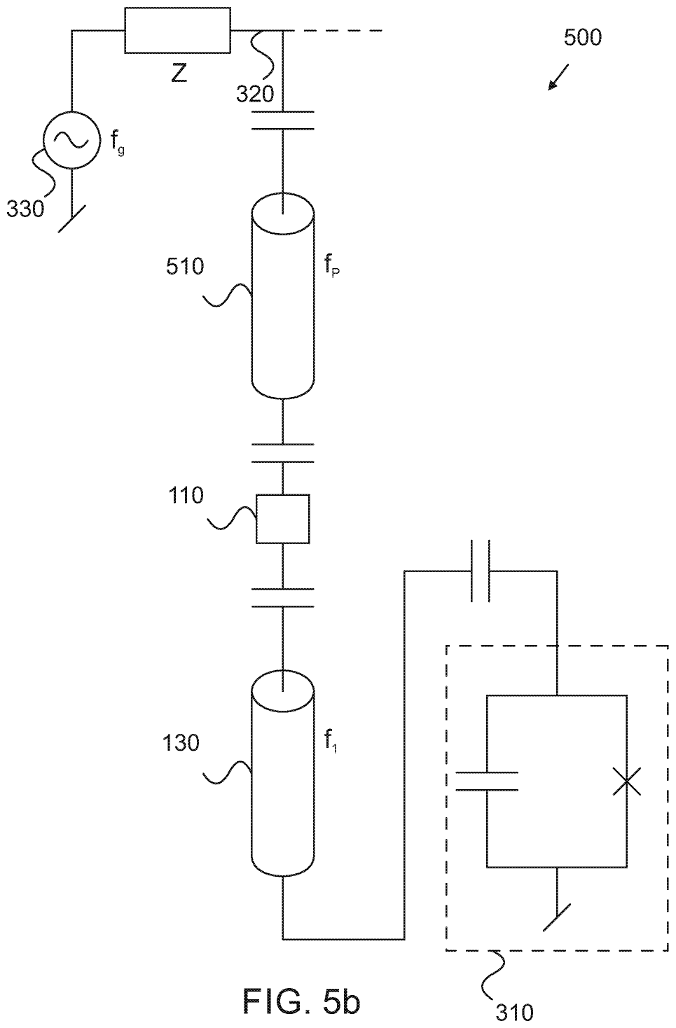

For solid-state qubits, a factor potentially limiting the qubit coherence is the decay through the readout resonator(s) to the input line. To mitigate this the calorimeters can be coupled to a Purcell filter for suppressing the relaxation at a qubit frequency. The Purcell-filter can also be used to suppress the impact of off-resonance driving effects present in multiplexed qubit readout. The readout arrangement, or the readout element, may comprise one or more Purcell-filters to suppress the decay of the quantum state of the qubit due to the dissipation stemming from the calorimeters. In FIGS. 5a and 5b, examples of a readout arrangement 500 are illustrated for this purpose. In these examples, the readout arrangement 500, or the readout element thereof, comprises one or more Purcell-filters 510, at least for frequency fₚ. As the Purcell-filter(s) can be part of the readout element, fₚ may be arranged specific to the specific qubit coupled to the readout element for determining its quantum state. The Purcell filter(s) may thus be bandpass filter(s) detuned from the qubit frequency so that the decay of the quantum state of the qubit can be suppressed.

The Purcell-filter(s) may be coupled to the qubit and/or to the input line 320 reactively. This includes capacitive and/or inductive coupling. For suppressing the decay of the quantum state of the qubit to the input line, the Purcell filter(s) 510 may be coupled between the calorimeters 110 and the input line 320. The Purcell filter(s) may be coupled directly to the feeder line, at an input of the readout element. They can thus be provided as the first signal-altering component of the readout element for external coupling, in particular to the input line. Also, the Purcell filter(s) may be coupled directly to the calorimeters, for example by reactive coupling such as capacitive coupling, as illustrated. As illustrated in FIG. 5a, the qubit 310 and, optionally, the resonator 130, may be coupled between (in series connection order) the input line 320 and the Purcell filter(s) 510, or the coupled combination of the Purcell filter(s) and the calorimeters. Alternatively, as illustrated in FIG. 5b, the Purcell filter(s) 510, or the coupled combination of the Purcell filter(s) and the calorimeters, may be coupled between (in series connection order) the input line 320 and the qubit 310 and, optionally, the resonator 130.

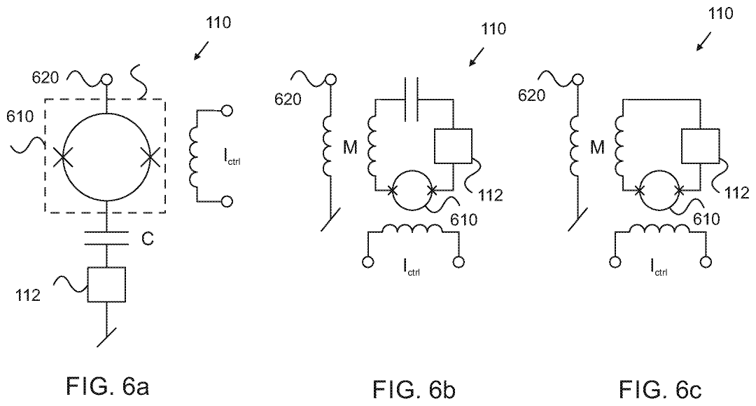

As any dissipation may be harmful to quantum coherence, it may be beneficial to arrange the dissipation stemming from the calorimeters in a tunable manner, as indicated above. For this purpose, the intrinsic dissipation of the calorimeters and/or the coupling of the calorimeters to the readout actuator may be tunable. This allows the dissipation stemming from the calorimeters to be increased or turned on as needed, for example in the context of a readout event. It also allows said dissipation to be decreased or turned off during quantum evolution of the qubit. In FIGS. 6a-c, examples of calorimeters having tunable dissipation are illustrated. Any of these calorimeters may be used in conjunction with the other examples provided herein, for example so that readout elements comprising both Purcell filter(s) and tunable calorimeter(s) may be provided. A tunable calorimeter may comprise one or more dissipative elements 112, such as an impedance and/or a resistance, for providing the output signal. The tunable calorimeter may be configured for tuning the coupling of the dissipative element(s) with respect to an input 620 of the calorimeter. In a readout element, such an input is coupled to the readout actuator for receiving readout signal so this also tunes the coupling of the dissipative element(s) to the readout actuator correspondingly tuning the dissipation stemming from the calorimeter to the readout element for determining the quantum state. In particular, the tunable calorimeter may be configured for tuning the coupling, and thereby the dissipation, by a control current I_{ctrl} tuning an effective inductance through a magnetic flux threading one or more SQUID (superconducting quantum interference device) loops. For this purpose, the tunable calorimeter may comprise one or more SQUID loops 610 coupled to the dissipative element(s), for example by a galvanic electric connection and/or a reactive connection, such as a capacitive connection. As illustrated in FIG. 6a, the SQUID loop(s) may be directly, or galvanically, connected to the input 620 of the calorimeter. As illustrated, the dissipative element(s) may be capacitively coupled to the SQUID loop(s). Alternatively, as illustrated in FIGS. 6a and 6b, the SQUID loop(s) may be reactively coupled to the input, for example through a mutual inductance M. For this purpose, the SQUID loop(s) may be situated in a separate circuit, which may include the dissipative elements(s). The dissipative element(s) may be galvanically (as in FIG. 6c) or reactively, for example capacitively (as in FIG. 6b), connected to the mutual inductance M.

In an embodiment, the readout actuator may comprise or consist of a Josephson transmission line (JTL, possibly including the other transmission lines as discussed above) for facilitating a readout signal to be provided from the (first) solid-state qubit for readout of the (first) quantum state. The quantum-state readout arrangement can be thereby be configured as a single flux quantum (SFQ) readout arrangement. The information of the quantum state may be converted into a fluxon, such as a fluxon pulse, propagating in the JTL. The readout arrangement may comprise a fluxon source. It may also comprise an SFQ-based readout system consisting of at least the JTL and optionally further SFQ circuit elements incorporating quantum-state dependent fluxon propagation for the (first) quantum state. Any SFQ fluxon source may be used as the fluxon source. As in the other embodiments, the output signal for determining the quantum state may be provided for the calorimeters based on the magnitude of the thermal energy and/or on the timing of the conversion of the readout signal into thermal energy. For the latter, the timing may correspond to timing information of a propagating fluxon pulse. In particular, the readout arrangement may be configured for utilizing the existence of a propagating fluxon alone as being an indication of the quantum state.

The JTL may be arranged to be operated in a ballistic mode for readout of the qubit. This allows minimizing losses experienced in a qubit. The JTL may also be arranged to be operated in an overdamped mode for readout of the qubit. Regardless of the mode, the energy of the fluxon may be arranged to be dissipated by the readout arrangement to allow stable operation. The calorimeters can be used as a dissipative load for terminating the JTL. The calorimeters may thus have a two-fold role: to stabilize the JTL and to act as a part of the readout element for detecting the fluxon. A fluxon, or an SFQ pulse, as a readout signal, can be more energetic, even significantly more so, than a readout pulse for a dispersive readout whence the energy resolution criteria may be significantly reduced. As an example, such a readout signal may comprise or consist of photons, which may number from tens to thousands. The readout signal may comprise or consist of photons having frequency of several GHz, for example 1-10 GHz, or around 5 GHz, in a specific example.

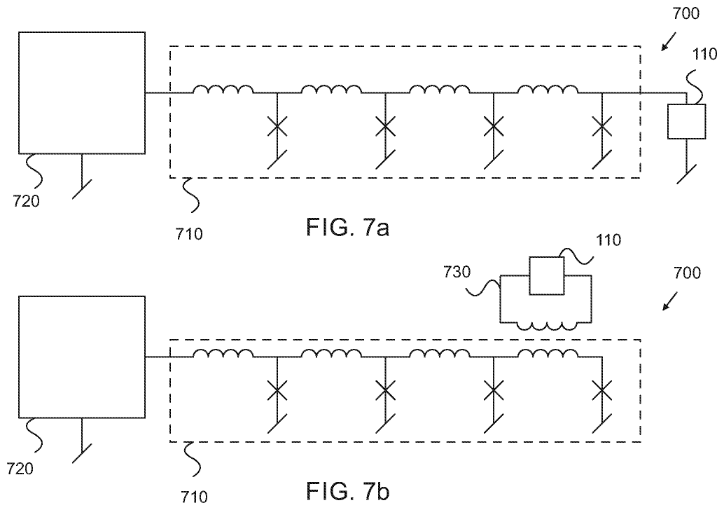

FIGS. 7a and 7b illustrate examples of a quantum-state readout arrangement 700 with the readout actuator comprising or consisting of a JTL 710. Other features of the readout arrangement, such as those related to the calorimeters 110, may be in accordance with any of the examples described above. For example, the calorimeters 110 of the readout arrangement may have a tunable dissipation, for example in accordance with any of the examples presented herein.

As state above, the readout arrangement 700 comprises a solid-state qubit. In FIGS. 7a and 7b, the qubit itself is not illustrated but the assembly 720 for providing the readout signal is. The assembly comprises the qubit. In addition, the assembly may comprise an actuator configured for facilitating initiating the conversion of the quantum state of the qubit into the readout signal and/or an actuator configured for initiating the conversion of the quantum state of the qubit into the readout signal. The input signal and/or the readout signal may comprise or consist of one or more fluxons, or one or more fluxon pulses. The JTL 710 may be coupled (in series connection order) between the qubit, or the assembly 720, and the calorimeters 110. The JTL may be coupled to the calorimeters by a galvanic electric connection and/or a reactive connection, such as a capacitive connection and/or an inductive connection. FIG. 7a illustrates an example, where the JTL 710 is coupled to the calorimeters by a galvanic electric connection. FIG. 7b illustrates an example, where the JTL 710 is coupled to the calorimeters by an inductive connection. This may be arranged, for example, through a mutual inductance between the JTL and a separate circuit 730 comprising the calorimeters 110. The separate circuit may comprise and inductive element 740 for facilitating the coupling through mutual inductance.

Importantly, the JTL may be configured for having a Stewart-McCumber parameter βc<100 for readout of the (first) quantum state. The dissipation stemming from the JTL may be described by the quality factor of the “plasma resonance” of the structure, for example for a Josephson junction and/or a SQUID loop (comprising a Josephson junction) of the JTL. Such a quality factor may be arranged to be close to unity. This can be quantified by the Stewart-McCumber parameter, which may be written as βc=2πI_{c}(Re(Z_{c}))²C_{JJ}/Φ₀, where I_{c} is the critical current of the Josephson junction, Re(Z_{c},) the real part of the impedance of the calorimeter(s) as seen by the readout element, or the JTL, C_{JJ} the capacitance of the Josephson junction, and Φ₀ the quantum of magnetic flux). The JTL may be configured to have βc<100 for allowing sufficient calorimeter-induced dissipation. However, in some embodiments, the performance may be further optimized by having βc<50 or βc<10. An additional marked effect may be obtained at βc<1, which can provide a strictly overdamped configuration. With this arrangement, the energy of the fluxon, propagating in the JTL, can be dissipated in the calorimeter. This allows, on one hand, preventing the fluxon from being reflected and, on the other hand, enabling the calorimetric detection of the flux quantum.

In accordance with what is disclosed above, the calorimeters may be coupled to a quantum circuit and a qubit-dependent readout signal may be coupled to the calorimeters to elevate their temperature. The calorimeters are thus thermal detectors.

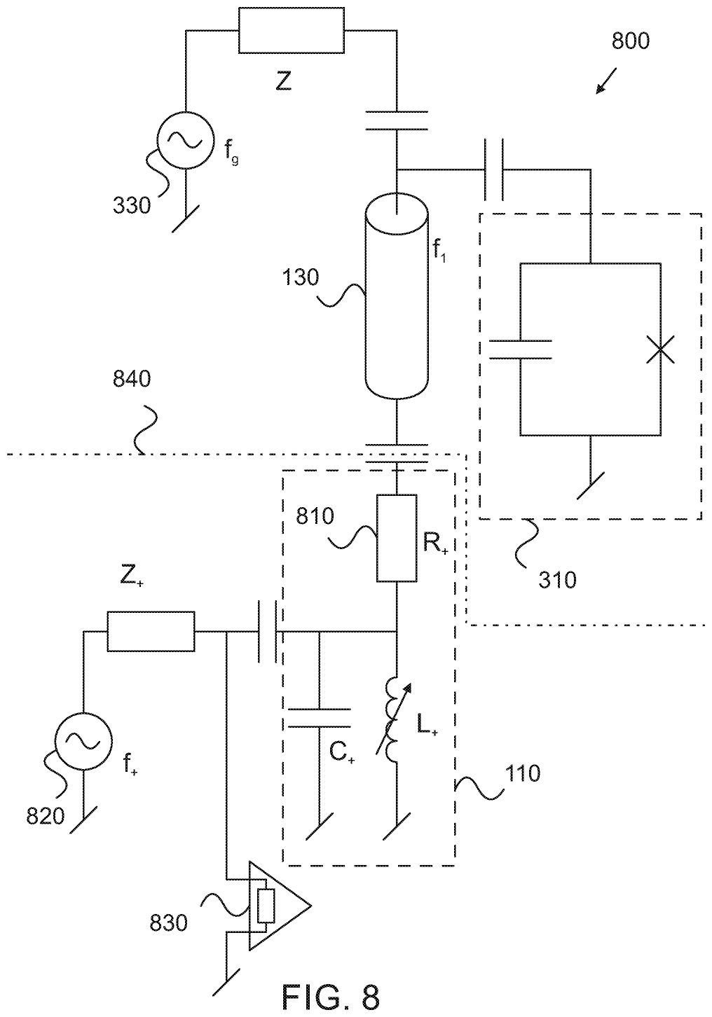

FIG. 8 illustrates a somewhat more detailed example of a readout arrangement 800 with a calorimeter as a thermal detector for determining the quantum state, in accordance with any of the disclosed embodiments, even though illustrated in conjunction of a resonator-based readout scheme. Correspondingly, it should be understood that the part above the dividing line 840 may be exchanged with any applicable setup comprising a solid-state qubit 310, a readout actuator and, optionally, a signal source 330, in accordance with the present disclosure.

The calorimeters 110 comprise one or more dissipative elements 810, such as resistive elements, for providing the output signal. The calorimeters may also have an inductance L₊ and/or capacitance C₊. For this purpose, the calorimeters may comprise one or more capacitive and/or inductive elements. The readout arrangement may comprise one or more output probes 820 for providing an output probe signal from each readout element for obtaining the output signal for determining the corresponding quantum state. One output probe may serve one or more qubits. The output probe signal may be a pulse signal and/or a microwave signal. The output probe, including any transmission lines for transmitting the output probe signal to the calorimeters, may exert an impedance Z₊ for the output probe signal.

The qubit-state-dependent absorption of the readout signal, which corresponds to the conversion of at least part of the readout signal into thermal energy for providing the output signal, in the dissipative element(s) 110 may increase an inductance L₊ of the calorimeters modulating the phase and/or the amplitude of the output probe signal. The output probe signal may have a frequency f₊ equal or close to a resonance frequency 1/(2π*sqrt (L₊*C₊)), where “sqrt (L₊*C₊)” denotes the square root of L₊*C₊. The resonance frequency may be configured to be below the frequency scale of the qubit 310 and, optionally, that of the readout resonator(s) 130.

In an embodiment the probing of the output of the calorimeters can be multiplexed. For this purpose, the readout arrangement may comprise a frequency-multiplexed output probe line for probing the output of multiple calorimeters, which may correspond to multiple qubits. In an embodiment, where the readout arrangement comprises a signal source for providing the input signal, the signal source can also be coupled to the calorimeters for providing the output probe signal. This allows reducing the number of transmission lines, such as RF lines, needed. The readout arrangement, and the signal source, may also be configured for applying the input signal as the output probe signal.

The readout arrangement may also comprise one or more amplifiers 830 coupled to the calorimeters 110 and, optionally, to the output probe(s) for amplifying the output signal. In general, it may allow easier signal processing, if the output signal of the calorimeters is sufficiently high to be detected easily in any sub-sequent elements of the readout chain. In an embodiment, the calorimeters are, at least partially, connected in cascade so that a second calorimeter is configured for reading the output signal of a first calorimeter. This allows relaxing the requirements of the post-amplification stages, or those of the amplifier(s) 830. This way, the calorimeters, as thermal detectors, may be configured for providing power gain for power amplification. In the example of RF-coupled calorimeters, the transmitted or reflected output signal and/or output probe signal may be absorbed by a second calorimeter.

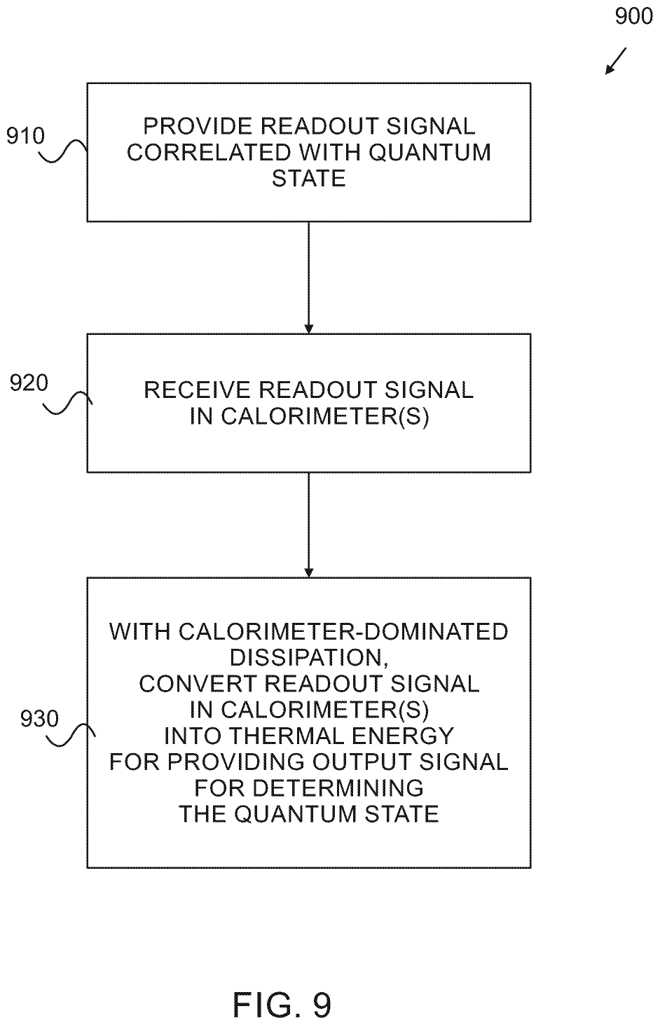

FIG. 9 illustrates a method according to an example. The method 900 may be used for quantum-state readout. It comprises providing a readout signal correlated with a quantum state of a solid-state qubit for readout of the quantum state. The readout signal may comprise or consist of, for example, a microwave signal or a fluxon, in accordance with any of the examples described above. The readout signal may be provided by probing a quantum state provided by a solid-state qubit to cause the readout signal to be provided for readout of the quantum state. The probing may be performed, for example by utilizing a signal source. An input signal may be provided for providing the readout signal from the qubit. It may be fed to one or more readout elements, for example through an input line. Providing the readout signal may also comprise facilitating transmission of the readout signal, such as a fluxon, from the qubit to one or more calorimeters. The method may comprise receiving 920, in one or more calorimeters, the readout signal for readout of the quantum state. The method may comprise converting 930, partially or fully, the readout signal in the one or more calorimeters into thermal energy for providing an output signal for determining the quantum state. In the method, the dissipation for the quantum-state readout can be arranged to be dominated by the dissipation stemming from the one or more calorimeters. For this purpose, a specifically configured readout arrangement may be provided, as indicated in accordance of any of the examples disclosed herein.

The arrangement as described above may be implemented in software, hardware, application logic or a combination of software, hardware and application logic. The application logic, software or instruction set may be maintained on any one of various conventional computer-readable media. A “computer-readable medium” may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer. The examples can store information relating to various processes described herein. This information can be stored in one or more memories, such as a hard disk, optical disk, magneto-optical disk, RAM, and the like. One or more databases can store the information used to implement the embodiments. The databases can be organized using data structures (e.g., records, tables, arrays, fields, graphs, trees, lists, and the like) included in one or more memories or storage devices listed herein. The databases may be located on one or more devices comprising local and/or remote devices such as servers. The processes described with respect to the embodiments can include appropriate data structures for storing data collected and/or generated by the processes of the devices and subsystems of the embodiments in one or more databases.

All or a portion of the embodiments can be implemented using one or more general purpose processors, microprocessors, digital signal processors, micro-controllers, and the like, programmed according to the teachings of the embodiments, as will be appreciated by those skilled in the computer and/or software art(s). Appropriate software can be readily prepared by programmers of ordinary skill based on the teachings of the embodiments, as will be appreciated by those skilled in the software art. In addition, the embodiments can be implemented by the preparation of application-specific integrated circuits or by interconnecting an appropriate network of conventional component circuits, as will be appreciated by those skilled in the electrical art(s). Thus, the embodiments are not limited to any specific combination of hardware and/or software.

The different functions discussed herein may be performed in a different order and/or concurrently with each other.

Any range or device value given herein may be extended or altered without losing the effect sought, unless indicated otherwise. Also any example may be combined with another example unless explicitly disallowed.

Although the subject matter has been de-scribed in language specific to structural features and/or acts, it is to be understood that the subject matter defined in the appended claims is not necessarily limited to the specific features or acts de-scribed above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The term ‘comprising’ is used herein to mean including the method, blocks or elements identified, but that such blocks or elements do not comprise an exclusive list and a method or apparatus may contain additional blocks or elements.

Numerical descriptors such as ‘first’, ‘second’, and the like are used in this text simply as a way of differentiating between parts that otherwise have similar names. The numerical descriptors are not to be construed as indicating any particular order, such as an order of preference, manufacture, or occurrence in any particular structure.

Expressions such as ‘plurality’ are in this text to indicate that the entities referred thereby are in plural, i.e. the number of the entities is two or more.

Although the invention has been the described in conjunction with a certain type of apparatus and/or method, it should be understood that the invention is not limited to any certain type of apparatus and/or method. While the present inventions have been described in connection with a number of examples, embodiments and implementations, the present inventions are not so limited, but rather cover various modifications, and equivalent arrangements, which fall within the purview of the claims. Although various examples have been described above with a certain degree of particularity, or with reference to one or more individual embodiments, those skilled in the art could make numerous alterations to the disclosed examples without departing from the scope of this specification.

1. A quantum-state readout arrangement comprising:
a first solid-state qubit for providing a first quantum state;
a readout element for determining the first quantum state, the readout element comprising:
a readout actuator for facilitating a readout signal to be provided from the first solid-state qubit for readout of the first quantum state; and
one or more calorimeters arranged to receive the readout signal and convert at least a part of the readout signal into thermal energy for providing an output signal for determining the first quantum state;
wherein the readout element is configured for its dissipation to be fixedly or tunably dominated by the dissipation stemming from the one or more calorimeters for the readout of the first quantum state.

2. The arrangement according to claim 1, wherein the readout actuator comprises a resonator coupled to the one or more calorimeters and the first solid-state qubit for forming a resonance circuit for the readout of the first quantum state and wherein the resonance circuit has a first quality factor indicating the intrinsic dissipation of the resonator and a second quality factor indicating the dissipation stemming from the one or more calorimeters, the second quality factor being smaller than the first quality factor.

3. The arrangement according to claim 2, comprising a second solid-state qubit for providing a second quantum state and a second readout element for determining the second quantum state; wherein the second readout element comprises a second resonator for readout of the second quantum state and wherein the resonator of the readout element has a first resonance frequency and the second resonator has a second resonance frequency different from the first resonance frequency.

4. The arrangement according to claim 1, wherein the readout actuator comprises a Josephson transmission line configured for having a Stewart-McCumber parameter β_{c}<100 for readout of the first quantum state.

5. The arrangement according to claim 1, wherein the output signal for determining the first quantum state is provided from the one or more calorimeters based on the magnitude of the thermal energy.

6. The arrangement according to claim 1, wherein the output signal for determining the first quantum state is provided from the one or more calorimeters based on the timing of the conversion of the readout signal into thermal energy.

7. The arrangement according to claim 1, wherein the one or more calorimeters comprise one or more electron temperature calorimeters.

8. The arrangement according to claim 1, comprising an input line for providing an input signal for providing the readout signal and one or more Purcell-filters coupled between the input line and the one or more calorimeters for suppressing the decay of the first quantum state due to the one or more calorimeters.

9. The arrangement according to claim 1, wherein the dissipation stemming from the one or more calorimeters is tunable.

10. The arrangement according to claim 9, comprising a tunable reactance coupled to the one or more calorimeters for tuning the dissipation stemming from the one or more calorimeters.

11. The arrangement according to claim 1, comprising a first chip and one or more second chips and wherein the first solid-state qubit is integrated on the first chip and the one or more calorimeters are integrated on the one or more second chips.

12. The arrangement according to claim 11, wherein one of the first chip and the one or more second chips is flipped on top of the other an electrical connection between the first chip and the one or more second chips for readout of the first quantum state is arranged by reactive coupling between the first chip and the one or more second chips.

13. The arrangement according to claim 1, wherein the one or more calorimeters comprises two or more calorimeters in cascade for providing the output signal for determining the first quantum state.

14. A method for quantum-state readout comprising:
providing a readout signal correlated with a quantum state of a solid-state qubit for readout of the quantum state;
receiving in one or more calorimeters the readout signal for readout of the quantum state; and
converting at least a part of the readout signal in the one or more calorimeters into thermal energy for providing an output signal for determining the quantum state;
wherein the dissipation for the quantum-state readout is fixedly or tunably dominated by the dissipation stemming from the one or more calorimeters for the readout of the quantum state.
